(19) United States
(12) Patent Application Publication
(10) Pub. No.: US 2003/0179981 A1
(43) Pub. Date: Sep. 25, 2003

(54) Tunable inorganic dielectric microresonators

(75) Inventors: Kevin K. Lee, Cambridge, MA (US); Kazumi Wada, Lexington, MA (US); Christian Hoepfner, North Andover, MA (US); Desmond R. Lim, Cambridge, MA (US)

Correspondence Address: HALE AND DORR, LLP, 60 STATE STREET, BOSTON, MA, 02109

(73) Assignee: LNL Technologies,Inc., Cambridge, MA

(21) Appl. No.: 10/104,927

(22) Filed: Mar. 22, 2002

(51) Int. Cl. G02B 6/26

(52) U.S. Cl. 385/15; 385/50

(57) ABSTRACT

A tunable waveguide microresonator device includes a core layer and a cladding layer surrounding said core. The cladding including regions surrounding the core where an evanescent field resides and at least one material of the core and the cladding is comprised of a photosensitive material. The resonance position of the microresonator is adjusted by irradiating the device with uv light.

### BACKGROUND OF THE INVENTION

1. Field of the Invention

The present invention is in the field of optics, and relates to optical modulators and switches that use closed loop resonators. In particular, the invention relates to changing the resonance characteristics of inorganic dielectric microresonators.

2. Prior Art

An optical microresonator includes a microcavity resonator having waveguides disposed adjacent to the microcavity for coupling of light into and out of the resonator. Microresonators are very small optical devices with dimensions of the order of 0.1 micrometers to 1 millimeter. Examples of such waveguide-based microresonators include optical microring resonators and one-dimensionally periodic photonic band gap waveguides structures.

Microresonators have attracted considerable attention due to their potential application in integrated optics for optical telecommunications. Microresonators can be designed to resonate at telecommunication wavelengths (1300-1600 nm) and are useful as add-drop filters in wavelength division multiplexing (WDM) applications in optical telecommunication. In WDM, each microresonator adds or drops a distinctive wavelength of light that is resonant with the device. In such applications, the ability to locally tune the resonance of the microresonator according to the specific wavelengths to be added or dropped is desired. Local tuning refers to the ability to control or alter the resonance of a single microresonator, even when the element is one of many on a densely architectured optical device.

Since the resonance conditions are very sensitive to the physical dimensions and material properties in the microresonators, the actual device characteristics of the fabricated microresonators are different from those obtained in computer simulations of the device. Such differences arise in the fabrication process which results in physical dimensions and properties that are slightly different from the actual design, as well as processing-induced variations. It is desired to have an ability to modify (or, in other words, to tune) the device characteristics after the fabrication process to match the specifications of the design. It is also desired that the tuning is permanent so that the device performance is fixed to the designed specifications once the microresonator is tuned.

Methods of modifying or tuning the characteristics of the resonance shape and position of a waveguide microresonator have been investigated in the past. Absorption and local proximity of multiple microresonators (cascaded microresonators) are among the methods used to alter resonator shape. These methods are difficult to implement because the amount of absorption that has to be induced is large for the absorption case, and because tight design and manufacturing tolerance is needed for the cascaded microresonator method. Therefore these methods are not really reproducible and reliable tuning methods.

The physical dimension of the device and the indices of refraction of the materials that make up the resonator cavity determine the resonance position, that is, the resonance wavelength or frequency. Changing either the dimension or the refractive indices of the microresonator can therefore change the resonance wavelength.

Tuning of microring resonators using a UV sensitive polymer as a cladding material of the microring resonator has been shown in the past (S. Chu et. al., IEEE Photonics Technol. Lett., 11(6): (June 1999)). Changing the index of refraction of the cladding by uv irradiation alters the effective and group indices of the mode of the microring waveguide, which results in a shift in the resonance line position. However, the use of polymers in optical devices is still in its infancy. The reliability and the compatibility with the current manufacturing methods remain as major challenges for polymers. Tuning of microresonators without using polymers is desired for reliability and manufacturability in optical device applications.

Changing the resonance of a semiconductor microresonators by changing the refractive index of the core has been reported. However, this method generally involves using the semiconducting properties of the microresonator core by injecting carriers, which is both difficult and prone to degradation of the core properties. This method works only with semiconducting materials.

Inorganic dielectric optical waveguides can exhibit the property of photosensitivity. Exposure of germanium-doped silica-on-silicon to uv energy results in a permanent change in refractive index. Photoirradiation has been used for writing buried waveguide grating structures. See, Bilodeau et al., Optics Lett. 18(12):953 (June 1993); and Bazylenko et al., Electron. Lett. 32(13):1198 (June 1996).

A method of tuning a microresonator that is locally tunable is needed for inorganic dielectric materials. Furthermore, a method of tuning a microresonator that is non-invasive to the mnicroresonator core is desired. A tunable microresonator having these and other desirable properties is needed.

### SUMMARY OF THE INVENTION

The present invention provides methods and tunable devices for permanently and locally changing the resonance of an inorganic dielectric optical microresonator.

In at least one embodiment, a waveguide microresonator device is provided. The device includes a microcavity resonator having a core layer and a cladding layer surrounding the core, wherein at least one material of the core and the cladding is comprised of a photosensitive material, and an input waveguide and an output waveguide, a portion of the input and output waveguides disposed adjacent to the microcavity. In at least some embodiments, the core is patterned. In at least some embodiments, the microresonator is a microring resonator. In at least some embodiments, the photosensitive material is uv sensitive.

In at least some embodiments, the photosensitive material comprises doped silica, wherein the dopant is selected from the group consisting of germanium, cesium, erbium and europium, or the photosensitive material includes germanium-doped silica. In at least some embodiments, the silica includes a silica host containing boron and phosphorous dopants.

In at least some embodiments, the core or the cladding includes the photosensitive material. In at least some embodiments, the cladding material has a graded index of refraction and the photosensitive material is located in the cladding adjacent to the core.

In at least some embodiments, the core includes silicon nitride or silicon oxynitride and the cladding includes germanium-doped silica, or the core includes germanium-doped silica and the cladding includes silica or air. In at least some embodiments, the core or the cladding is selected from the group consisting of germanium-doped silicon nitride and germanium-doped silicon oxynitride.

In another aspect of the invention, an inorganic dielectric resonator device is tuned by irradiating a microresonator device including a core layer, a cladding layer surrounding the core and an input waveguide and an output waveguide, wherein at least one material of the core and the cladding includes a photosensitive material, and wherein a portion of the input and output waveguides are disposed adjacent to the microcavity at a wavelength of light to which the photosensitive material is sensitive.

In at least some embodiments, the device is exposed incrementally to uv and the resonance position is determined between uv exposures.

In at least some embodiments, the photosensitive material includes germanium-doped silica and the wavelength of light is about 240 nm.

By “patterned,” as that term is used herein, it is meant that the material is arranged and/or provided in a predetermined configuration. Most often, the pattern is made using semiconductor fabrication methods, such as lithography. The ability to use patterned elements in the microresonator and the ability to use conventional semiconductor fabrication techniques permits incorporation of the microresonators of the invention into optical devices or optical chips.

By “photosensitive” or “photosensitivity” is meant sensitivity to light so that a chemical, electronic or physical change occurs in the material. Exposure to light can alter the refractive index of the material. Light can range across the spectrum and includes us, visible and IR light.

By “local” tuning a microresonator, it is meant that the tuning process is able to isolate and selectively modify a microresonator. In operation, is it contemplate that the microresonator is incorporated into an optical chip, where other optical and/or electrical functions also reside in close proximity. Local tuning permits the selective tuning of the selected microresonator without effecting adjacent elements on the chip.

### BRIEF DESCRIPTION OF THE DRAWING

The invention is described with reference to the following figures, which are presented for the purpose of illustration only and which are not intended to be limiting of the invention.

FIG. 1A is a schematic illustration of an exemplary microresonator; and FIG. 1B is a plot or transmission vs. wavelength showing the resonance position of the microresonator.

FIG. 2 is a schematic illustration of an exemplary waveguide microring resonator cavity.

FIG. 3A is a schematic illustration of a tunable microresonator of the invention for which the photosensitive material is used as a cladding material; and FIG. 3B is a schematic illustration of a tunable microresonator of the invention for which the photosensitive material is used in a graded cladding material.

FIG. 4 is a schematic illustration of a tunable microresonator of the invention for which the photosensitive material is used as the core material.

FIG. 5 is a plot or transmission vs. wavelength showing the shift in resonance position of the microresonator upon uv irradiation of the device according to at least one embodiment of the invention.

### DETAILED DESCRIPTION OF THE INVENTION

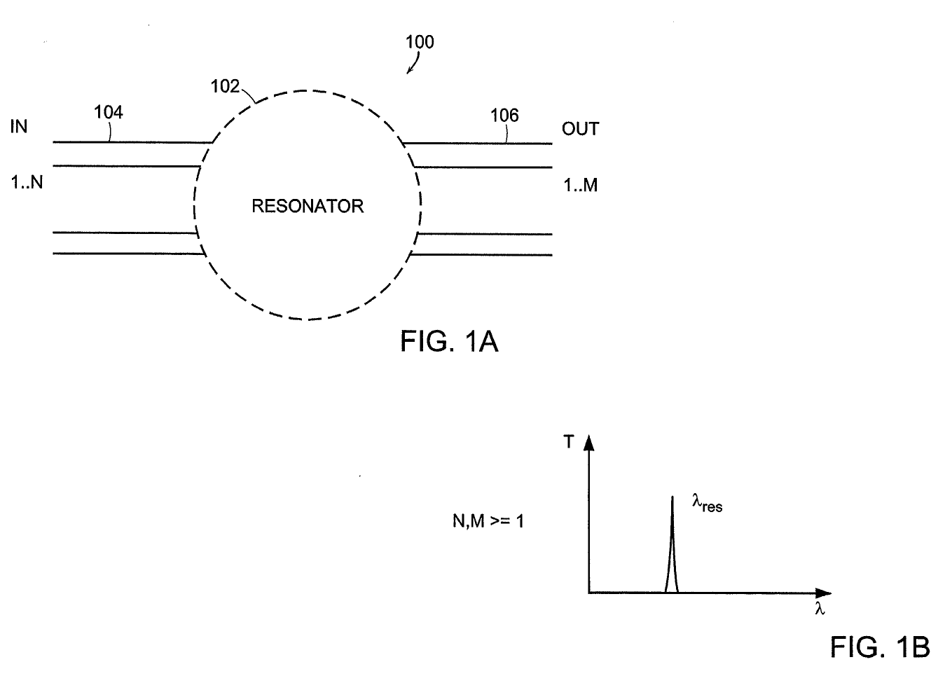

FIG. 1A is a schematic illustration of an exemplary microresonator 100. The resonator includes a generic resonator cavity 102 with N input waveguides 104 and M output waveguides 106. The response of at least one of the output waveguides of the microresonator cavity is shown in FIG. 1B in a plot of transmission vs. wavelength (λ). For purposes of illustration, the resonance is defined as the sharp spike shown in the inset and the wavelength, λᵣₑₛ, is the position of the resonance in the wavelength spectrum.

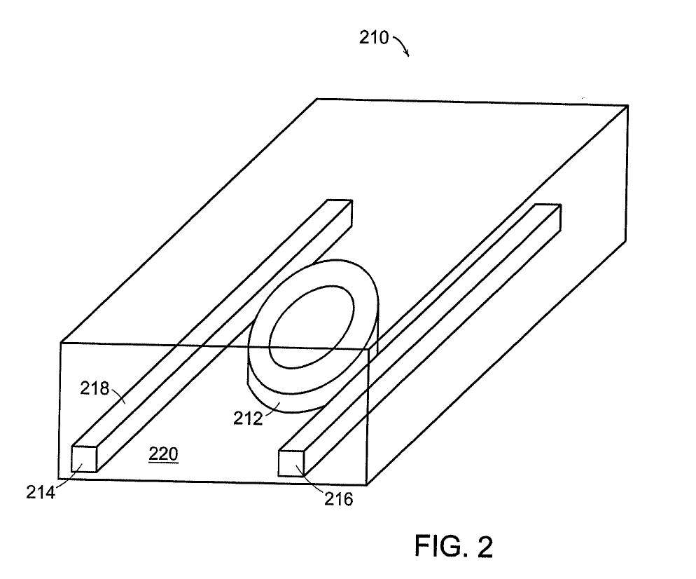

FIG. 2 is a schematic illustration of an exemplary waveguide microring resonator cavity 210. The microring resonator has a waveguide ring 212 coupled to two bus waveguides 214, 216. The bus waveguides 214, 216 are placed in close proximity (e.g., within the evanescent field) to the microring in order to interact with the resonator mode. The microring resonator is a waveguide of higher index material 218 in the core surrounded by a lower index material 220 in the cladding, which forms a high confinement (high index difference) waveguide. The high confinement of the waveguide allows for low propagation loss around the bends of the small ring.

Light enters the microring 212 from the first bus waveguides 214 and a small fraction of the light energy is then coupled into the ring. After a trip around the ring, light that is resonant in the ring adds in phase with light already resident in the ring. Power then builds up and reaches a steady state. Resonant light is then coupled into the second bus waveguide 216 and exits the microresonator. Wavelengths of light that are off-resonance with the microring never build up power and the energy in the input waveguide travels past the ring without effect.

According to one embodiment of the invention, the resonance position of the microresonator is changed or “tuned” by use of a photosensitive material in the waveguide microresonator. The index of the photosensitive material is adjusted upwards or downwards by exposure of the device to light of the appropriate wavelength, thereby altering the index difference and the resonance position of the device. Because the light exposure can be in the form of a narrow beam or can be focused, it is possible to locally alter the index and, hence, locally tune the microresonator.

Any photosensitive dielectric material that changes its refractive index upon irradiation can be used in the practice of the present invention. By way of example, germanium, cerium, europium and erbium all show varying degrees of uv sensitivity when doped into a silica host. The silica host itself can be a doped silica. Exemplary silica host includes boron and/or phosphorous doped silica.

Germanium-doped silica (Ge:SiO₂) is widely used as a core material for optical fibers and planar waveguides. Doping Ge into the silica serves to raise the refractive index of the core material relative to the cladding (typically, undoped SiO₂). For example, 4 mol % Ge—SiO₂ has a refractive index of 1.478, while the index of 15 mol % Ge—SiO₂ is raised to 1.498. See, Bazylenko et al., supra. A similar increase in refractive index was observed by flame brush treatment (heating with an oxy-hydrogen flame in a hydrogen-rich atmosphere) of Ge-doped SiO₂ on a silica substrate (Bilideau et al., supra.).

Ge:SiO₂ also exhibits excellent photosensitivity. Uv irradiation at the absorption peak of a Ge-related defect (ca. 240 nm) increases the refractive index of the sample at longer wavelengths. Thus, exposure of the Ge:SiO₂ material to ultraviolet light (ca. 240 nm) alters the refractive index of the material by about 0.002. The magnitude of the change in index is related to the time and intensity of uv exposure.

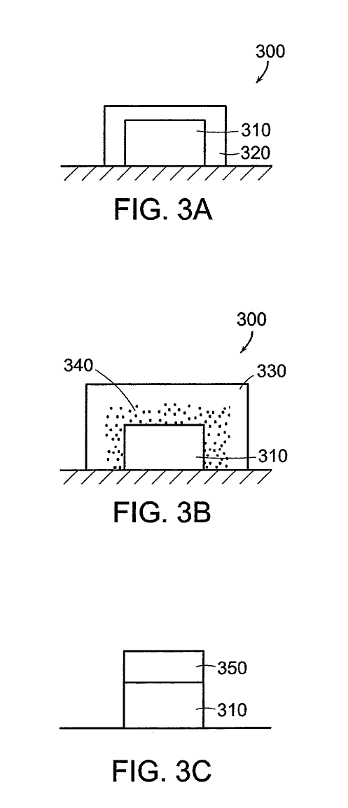

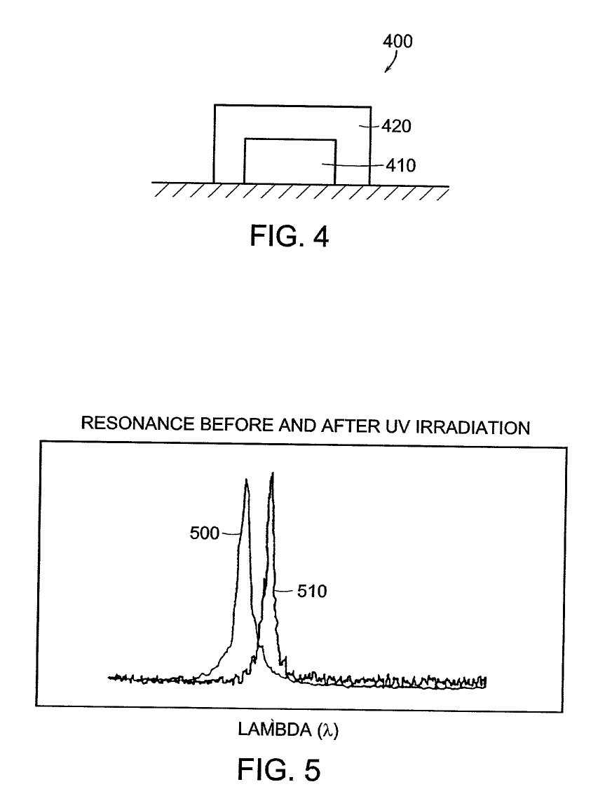

This difference can be exploited to obtain a tunable microresonator. According to at least one embodiment of the invention, a microresonator 300 incorporates a photosensitive material into the waveguide resonator as either the cladding or the core material. The microresonator can include a high index core and a cladding material, in which at least a portion of the cladding material is a photosensitive material, e.g., Ge-doped silica. As is shown in cross section in FIG. 3A, the microring waveguide 300 can include high index core 310, e.g., silicon nitride (n=2.00-2.05) or silicon oxynitride (n=1.80), and a low index cladding 320, e.g., Ge-doped SiO₂ (n=1.48-1.50). The substrate is a low index material, such as SiO₂. Alternatively, as is shown in FIG. 3B, the cladding can be a graded cladding 330 with varying dopant content, including a high Ge-dopant region 340 located closest to the high index core, i.e., having enough effect to adequately change the effective index of the device. The outermost portion of the cladding can have an index close to or equal to that of undoped silica (n=1.47). Graded coatings can be prepared using conventional techniques. See, WO 02/04999 (our published PCT) for further details. In at least some embodiments of the invention, the Ge-doped silica cladding covers less than all sides of the core. In FIG. 3C, an embodiment of the invention illustrates this point. The cladding includes a top layer 350 of photosensitive material, while the sides use air as the low index cladding.

In at least some embodiments of the invention, microresonator 400 incorporates tunable Ge-doped silica into the waveguide resonator as the high index core 410. Undoped silica or air (n=1.0) can serve as the low index cladding 420. As in the previous discussion, the cladding can include air surrounding the core, in whole or in part.

In each of these architectures, the uv irradiation preferentially effects only the uv sensitive layer and leaves the properties of the other layers unchanged. In those instances where the Ge-doped silica is used as a core, silica can be used as the cladding, which is transparent to the uv radiation and allows the activating light to penetrate to the core of the waveguide unattenuated. In this sense, it is an optimal tuning process because the other layers are transparent to uv and are not affected, while the tuning energy is directed to the material where is can effect a change in the refractive index.

Tuning is accomplished by exposing the device to uv irradiation at a wavelength to which the device is sensitive. Because the magnitude of the change in index is a function of time and intensity of uv exposure, it is possible to incrementally irradiate the device until the desired index shift is accomplished. FIG. 5 is a plot of transmission vs. wavelength and show an exemplary plot of the resonance position before (500) and after (510) irradiation.

The uv irradiation can be provided by a uv laser or a uv lamp. The localization of the uv irradiation may be accomplished by focusing the light using some optical elements such as lens. However focusing is not required if the beam size is small enough for localized irradiation depending on specific applications.

Ge doping in SiO₂ can be achieved through conventional methods. One method is to mix a Ge-containing precursor with other precursors used to create SiO₂ in a chemical vapor deposition (CVD) process. For example, Ge-doped silica films are deposited from a mixture of silane (SiH₄), germane (GeH₄) and oxygen. Another method is to incorporate Ge in a sputtering process by using Ge target as well as other targets to deposit SiO₂.

What is claimed is:

1. An inorganic dielectric microresonator device comprising:
a microcavity resonator comprising a core layer and a cladding layer surrounding said core, wherein at least one material of the core and the cladding is comprised of a photosensitive material; and
an input waveguide and an output waveguide, a portion of the input and output waveguides disposed adjacent to the microcavity.

2. The device of claim 1, wherein the core is patterned.

3. The device of claim 1, wherein the microresonator is a microring resonator.

4. The device of claim 1, wherein the photosensitive material comprises doped silica, wherein the dopant is selected from the group consisting of germanium, cesium, erbium and europium.

5. The device of claim 1, wherein the photosensitive material comprises germanium-doped silica.

6. The device of claim 5, wherein silica comprises a silica host containing boron and phosphorous dopants.

7. The device of claim 1, wherein the photosensitive material is uv sensitive.

8. The device of claim 1, wherein the core is comprised of the photosensitive material.

9. The device of claim 1, wherein the cladding is comprised of the photosensitive material.

10. The device of claim 9, wherein the cladding material has a graded index of refraction and the photosensitive material is located in the cladding close to the core, having enough effect to adequately change the effective indices of the device.

11. The device of claim 1, wherein the core comprises silicon nitride or silicon oxynitride and the cladding comprises germanium-doped silica.

12. The device of claim 1 wherein the core comprises germanium-doped silica and the cladding comprises silica or air.

13. The device of claim 1, wherein the core is selected from the group consisting of germanium-doped silicon nitride and germanium-doped silicon oxynitride.

14. A method of tuning a waveguide microresonator device comprising:
providing a microresonator device comprising a core and a cladding surrounding said core, wherein at least one material of the core and the cladding is comprised of a photosensitive material; and an input waveguide and an output waveguide, a portion of the input and output waveguides disposed adjacent to the microcavity; and
irradiating the device at a wavelength of light to which the photosensitive material is sensitive.

15. The method of claim 14, wherein the device is exposed incrementally to uv and the resonance position is determined between uv exposures.

16. The method of claim 14, wherein the photosensitive material comprises germanium-doped silica and the wavelength of light is about 240 nm.
